(19) United States
(12) Patent Application Publication
(10) Pub. No.: US 2006/0057246 A1
(43) Pub. Date: Mar. 16, 2006

(54) Drinking water for poultry and breeding method of poultry

(76) Inventors: Mana Itakura, Aichi (JP); Tsutomu Fujihara, Aichi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/086,434

(22) Filed: Mar. 23, 2005

(30) Foreign Application Priority Data
Mar. 25, 2004 (JP) 2004-089246
Feb. 16, 2005 (JP) 2005-038983

(51) Int. Cl. A23K 1/18

(52) U.S. Cl. 426/2

(57) ABSTRACT

In breeding of poultry, electrolyzed mildly alkaline water produced by electrolysis of pure water in an electrolytic cell with an ion permeable membrane is used as a drinking water of the poultry to improve ingestion and digestion of the feed in the poultry and to decrease an amount of environmental pollutant contained in excrements.

### BACKGROUND OF TMIE INVENION

1. Field of the Invention

The present invention relates to drinking water used with feed for breeding poultry and to a breeding method of poultry in which such drinking water is provided to poultry.

2. Discussion of the Prior Art

Poultry such as chicken has faculties to keep ingest of energy almost constant in breeding and, except for abnormal breeding environment, they decrease ingest of feed when an energy level of feed is high, and keep ingest of energy almost constant. For this reason, it becomes a subject for breeding method how to increase ingest of energy with lower amount of feed. In addition, in poultry breeding, when poultry were provided with the feed containing excessive amino acid, that leads to excretion of abnormal proportion of amino acid, and such an excretion consume a considerable amount of energy, that leads to a waste of feed energy and protein. Furthermore, increased nitrogen components excreted in the urine raises nitrogen loading, which becomes a subject to reduce the effects on the environment.

Moreover, a purpose of egg laying of poultry is basically to leave offspring, so composition of an egg is rarely affected by the component of feed; however, the amount of vitamins or minerals in the component, color of yolk, or component of fatty acid are affected by the component of the feed. For this reason, production of specially processed eggs with particular component of egg is attempted. Furthermore, egg yolk contains almost all the fat of an egg, and fatty acid of such fat is an important element to determine a flavor of an egg, and production of eggs with nutritively particular component of fatty acid is attempted.

Heretofore, various methods are proposed to solve problems that occur in breeding in which particular functional water as drinking water for breeding that given in breeding of domestic animals including poultry. “Breeding Method of Domestic Animals” disclosed in Japanese Patent Publication No. H7-227219 is a breeding method in which high-oxygen water containing at least 30 ppm of oxygen, which controls creation of ammonia by improving enterobacteria of domestic animals using the function of high-oxygen water. In such breeding method, without using drugs or lowering breeding result or yield, or any negative influence on domestic animals, creation of ammonia is controlled effectively, and domestic animals are fatten effectively, and pollution factors in breeding are decreased.

“Water for Breeding of Terrestrial Animals” disclosed in Japanese Patent Publication No. H11-221026 is electrolyzed water, in which sodium level is under 200 ppm and pH is between 4.5 and 6.8 in electrolyzed weakly acid water produced by electrolysis of hydrochloric acid solution without containing sodium in an electrolytic cell without an ion permeable membrane. Such water for breeding is useful for health maintenance and prevention of disease of terrestrial animals because it is practically neutral without containing any sodium, with little corrosion of equipments for breeding, and suitable for drinking.

However, the breeding method of poultry using the above-mentioned “Breeding Method of Domestic Animals” disclosed in Japanese Patent Publication No. H7-227219 cannot achieve objectives such as improving digestion and use of feed for poultry or having poultry laid specially processed eggs. On the other hand, the breeding method of poultry using drinking water of “Water for Breeding of Terrestrial Animals” disclosed in Japanese Patent Publication No. H11-221026 cannot achieve objectives such as improving digestion and use of feed for poultry, cutting environmental pollutant in excrement of poultry, or having poultry laid specially processed eggs.

### SUMMARY OF THE INVENTION

It is, therefore, an object of the present invention to provide a drinking water and a breeding method capable of improving ingestion and digestion of feed in poultry and of decreasing environmental pollution matter contained in excrements of poultry.

Another object of the present invention is to provide a drinking water and a breeding method capable of rendering poultry a specially processed eggs.

According to the present invention, the objects are accomplished by providing electrolyzed mildly alkaline water produced by electrolysis of pure water in an electrolytic cell with an ion permeable membrane as a drinking water used with feed for breeding poultry. In a practical embodiment of the present invention, it is preferable that electrolyzed mildly alkaline water of pH 8-11 is provided as the drinking water of poultry.

In a breeding experiment of poultry using electrolyzed alkaline water as a drinking water of the poultry, the accumulation rate of nitrogen in poultry was increased, and protein was efficiently accumulated in the poultry. As a result, it has been found that a breeding management using poultry feed of low protein could be carried out for saving of the poultry feed if the electrolyzed alkaline water was used as the drinking water of the poultry.

In the breeding experiment of poultry using electrolyzed alkaline water, it has been confirmed that the weight of interperitoneal fat, the lipid concentration in liver and breast meat and the concentration of triglyceride are increased. As a result, a breeding management using poultry feed of low fat could be carried out for saving of the poultry feed if the electrolyzed alkaline water was used as the drinking water to cause efficient ingestion of fat in the poultry feed.

Furthermore, in the breeding experiment using the electrolyzed alkaline water as the drinking water of poultry, the metabolic energy of the poultry was increased, the energy in the poultry feed was efficiently ingested by the poultry. As a result, it has been confirmed that a breeding mangagement using poultry feed of low energy could be carried out for saving of the feed if the electrolyzed alkaline water was used as the drinking water of the poultry.

In the breeding experiment using the electrolyzed alkaline water as the drinking water of poultry, the accumulation rate of nitrogen, the accumulation rate of crude fat and the metabolic energy of the broiler chickens were increases, and all the nutrition in the poultry feed was effectively ingested to decrease an amount of organic matter in excrements of the poultry. Thus, a breeding management of poultry can be carried out under low loading to environment.

The breeding of broiler chickens using the electrolyzed alkaline water as the drinking water greatly affects lipid metabolism of the broiler chickens. This fact suggests possibility of production of specially processed eggs characterized in fat. Accordingly, it is able to produce eggs richly containing fatty acid such as eicosapentaenoic acid (EPA), docosahexaenoic acid (DHA) and the like. It is also able to produce eggs rich in flavor and controlled in fatty acid contained in yolk These eggs are appreciated as value-added eggs. The former eggs are effective to ingest fatty acid such as eicosapentaenoic acid (EPA), docosahexaenoic acid (DHA) and the like, while the latter eggs are effective to taste the flavor of them.

### DESCRIPTION OF PREFERRED EMBODIMENTS

The present invention relates to a drinking water used with feed for breeding poultry and to a breeding method of poultry with the drinking water. Hereinafter, a breeding method of broiler chickens will be described as a practical embodiment of the present invention.

In the breeding method of broiler chickens, broiler chickens (male) of two-week-age were bred for eighteen days. In the breeding, the broiler chickens were freely fed with poultry feed and drinking water. Used as the drinking water was electrolyzed mildly alkaline water of pH 8-11 produced by electrolysis of normal pure water in an electrolytic cell with an ion permeable partition membrane. In the electrolytic cell, the pure water is supplied to an anode chamber and a cathode chamber and is electrolyzed to produce electrolyzed acid water in the anode chamber and electrolyzed alkaline water in the cathode chamber. In this embodiment, the electrolyzed alkaline water was prepared as mildly alkaline water of pH 8-11 to be used as the drinking water of the broiler chickens.

As a result of the breeding of the broiler chickens of two-week-age for eighteen days, it has been found that the body weight of the broiler chickens bred in a condition where the electrolyzed mildly alkaline water was freely fed was increased more than that of the broiler chickens bred in a condition where tap water was freely fed, despite that ingestion of the same poultry feed was almost the same amount. Also, the following facts have been found; an increase of the weight of internal organ such as liver, breast meat and the like, an increase of the weight of interperitoneal fat, an increase of the lipid concentration of internal organ such as liver, breast meat and the like, an increase of the accumulation rate of crude fat, the accumulation rate of nitrogen and the metabolic energy, and an increase of the triglyceride concentration in blood plasma.

From the above facts, it has been confirmed that the broiler chickens effectively ingest the fat, nitrogen and energy in the poultry feed. This means that a breeding management using poultry feed of low fat, low protein and low energy can be carried out for saving of the poultry feed. In the breeding experiment of the broiler chickens, the accumulation rate of nitrogen, the accumulation rate of crude fat and the metabolic energy of the broiler chickens were increased, and all the nutrition in the poultry feed was effectively ingested to decrease an amount of organic matter contained in excrements. This means that a breeding management can be carried out under low load to environment

The breeding of broiler chickens using the electrolyzed mildly alkaline water as the drinking water greatly affects lipid metabolism of the broiler chickens. This fact teaches possibility of production of specially processed eggs characterized in fat. Accordingly, it is able to produce eggs richly containing fatty acid such as eicosapentaenoic acid (EPA), docosahexaenoic acid (DHA) and the like. It is also able to produce eggs rich in flavor and controlled in fatty acid contained in yolk These eggs are appreciated as value-added eggs. The former eggs are effective to ingest fatty acid such as eicosapentaenoic acid (EPA), docosahexaenoic acid (DHA), while the latter eggs are effective to taste the flavor of them.

### FIRST EMBODIMENT

In this embodiment, a breeding experiment of chickens with usual poultry feed and electrolyzed mildly alkaline water was carried out in comparison with a breeding experiment of chickens with usual poultry feed and usual drinking water (tap water). In each breeding experiment, male broiler chickens of two-week-age were bred, and two kinds of drinking water (BEW) and (TAP) listed in the following table 1 were used for breeding. The drinking water (BEW) is the electrolyzed mildly alkaline water according to the present invention, while the drinking water (TAP) is the tap water usually used for breeding of the broiler chickens.

TABLE 1
Characteristic of drinking water

Drinking water

| Characteristic | BEW | TAP |
|---|---|---|
| pH | 9.8 | 7.5 |
| Na+(mg/L) | 16.6 | 13.6 |
| Ca+(mg/L) | 3.6 | 3.3 |
| Mg2+(mg/L) | 1.1 | 0.8 |
| K+(mg/L) | 1.9 | 1.8 |

In the embodiment, 36 broiler chickens were divided into two groups of 18 chickens which were respectively bred in a section (BEW) for feeding the drinking water (BEW) and in a section (TAP) for feeding the drinking water (TAP). The broiler chickens were bred for eighteen days from December 1 in a condition where they could freely ingest the poultry feed and drinking water. For supply of the drinking water (BEW), the electrolyzed mildly alkaline water (BEW) produced in an electrolytic cell (not shown) was temporarily stored in a tank of polyethylene and continuously supplied into a water suppler of the trough type. For supply of the driving water (TAP), the tap water (TAP) was temporarily stored in a tank of polyethylene and continuously supplied into a water suppler of the trough type. Provided that the drinking water stored in the tank were replaced with fresh drinking water at 9 o'clock and 17 o'clock every day.

In the breeding experiments, the ingested amount of poultry feed and an increased amount of the body weight during the breeding period were measured, and each weight of liver, breast meat and interperitoneal fat were measured after finish of the breeding. The breeding period was divided into a first period (December 5 to 12), a second period (December 9 to 13), and a third period (December 14 to 17). Excrements in each period were collected, and an amount of crude fat (an accumulation rate of crude fat %), an amount of nitrogen (an accumulation rate of nitrogen %) and an amount of energy (metabolic energy cal/gDM) accumulated in the body of the broiler chickens were calculated based on each amount of crude fat, nitrogen and energy in the collected excrements. After finish of the breeding, blood was extracted from the broiler chickens to measure the whole cholesterol (CHOL) and triglyceride (TG) in its blood plasma. The result of each measurement obtained by the breeding experiments is shown in the following tables 4 to 8.

TABLE 2
Result of body increase

Drinking water

| Item | TAP | BEW |
|---|---|---|
| Body weight at start (g) | 324.0 | 323.0 |
| Body weight at finish (g) | 1212.5 ± 30.2 | 1278.6 ± 37.6 |
| Ingestion amount of feed (g) | 2878 | 2949 |
| Efficiency of feed | 0.59 | 0.60 |

TABLE 3
Weight of internal organ (g)

Drinking water

| Item | TAP | BEW |
|---|---|---|
| Liver | 28.6 ± 1.0 | 32.0 ± 1.2 |
| Breast meat | 57.9 ± 1.7 | 60.8 ± 2.7 |
| Interperitoneal fat | 5.5 ± 0.7 | 7.6 ± 0.7 |

TABLE 4
Concentration of internal organ fat (%)

Drinking Water

| Item | TAP | BEW |
|---|---|---|
| Liver | 11.2 ± 0.4 | 12.9 ± 0.2 |
| Breast meat | 2.2 ± 0.3 | 3.2 ± 0.3 |

TABLE 5
Accumulation rate of crude fat (%)

Drinking water

| Item | TAP | BEW |
|---|---|---|
| First period | 86.8 ± 0.3 | 88.0 ± 0.5 |
| Second period | 86.4 ± 0.6 | 87.7 ± 0.5 |
| Third period | 87.1 ± 0.5 | 87.5 ± 0.8 |

TABLE 6
Accumulation rate of nitrogen (%)

Drinking Water

| Item | TAP | BEW |
|---|---|---|
| First period | 62.9 ± 1.4 | 67.9 ± 1.4 |
| Second period | 60.2 ± 2.5 | 60.9 ± 5.6 |
| Third period | 59.4 ± 1.2 | 60.2 ± 2.8 |

TABLE 7
Metabolic energy (cal/gDM)

Drinking Water

| Item | TAP | BEW |
|---|---|---|
| First period | 3717 ± 20 | 3813 ± 15 |
| Second period | 3645 ± 27 | 3717 ± 55 |
| Third period | 3618 ± 22 | 3633 ± 30 |

TABLE 8
Property of blood (mg/dL)

Drinking Water

| Item | TAP | TAP |
|---|---|---|
| TG | 26.3 ± 1.4 | 30.3 ± 1.0 |
| CHOL | 170.3 ± 5.5 | 164.2 ± 4.0 |

From the result of body increase listed in the table 2, it has been found that the body weight of the broiler chickens in the BEW section was increased more than that of the broiler chickens in the TAP section during the period of breeding, despite that ingestion of the same poultry feed was almost the same amount. According to the weight of internal organ and the concentration of internal organ fat respectively listed in the tables 3 and 4, it has been confirmed that the internal organ and the concentration of internal organ fat of the broiler chickens in the BEW section were increased more than those of the broiler chickens in the TAP section. In this respect, it is assumed that the increase of the internal organ weight of the broiler chickens in the BEW section is caused by the increase of the concentration of internal organ fat.

With respect to the accumulation rate of crude fat, the accumulation rate of nitrogen and the accumulation rate of energy respectively listed in the tables 5, 6 and 7, it has been found that each accumulation of the crude fat, nitrogen and metabolic energy of the broiler chickens in the BEW section was increased more than that of the broiler chickens in the TAP section. As the accumulation rate of crude fat is an index of the ingestion efficiency of fat in the poultry feed, the increase of the accumulation rate of fat indicates an increase of the body fat of the broiler chickens. As the accumulation rate of nitrogen is an index of the ingestion efficiency of protein in the poultry feed, the increase of nitrogen indicates an increase of meat production caused by protein. As the metabolic energy is an index of the ingestion efficiency of energy, the energy ingested from the poultry feed is utilized to maintain the metabolic function and body increase of the broiler chickens.

With regard to the blood property listed in the table 8, it has been confirmed that the triglyceride of the broiler chickens in the BEW section was increased more than that of broiler chickens in the TAP section. As the blood property is a clinical index related to internal lipid metabolism, it has been confirmed that the triglyceride (a kind of neutral lipid) of the broiler chickens in the BEW section was increased more than that of the broiler chickens in the TAP section.

### SECOND EMBODIMENT

In this embodiment, a breeding experiment of chickens was carried out substantially in the same manner as in the first embodiment, wherein a breeding of broiler chickens with usual poultry feed and electrolyzed mildly alkaline water was carried out in comparison with a breeding of the broiler chickens with usual poultry and usual drinking water (tap water). In the breeding experiments, two kinds of drinking water (BEW) and (TAP) listed in the table 1 were used for breeding broiler chickens (male) of two-week-age.

In the embodiment, forty (40) broiler chickens were divided into two groups of twenty (20) chickens which were respectively bred in a section (BEW) for feeding with the drinking water (BEW) and in a section (TAP) for feeding with the drinking water (TAP). The broiler chickens were bred for fourteen days in a condition where they could freely ingest the poultry feed and the drinking water supplied from a Nipple watering system for cage.

The Nipple watering system is provided with a plurality of nipples in connection to a water supply pipe. The nipples are arranged to discharge the drinking water from the water supply pipe when pecked by the broiler chickens. In the water watering system, the drinking water does not stagnate in a condition exposed to the outside air in a hencoop. This is useful to maintain the hencoop in a sanitary environment, to restrain the occurrence of environmental pollution caused by wastewater and to prevent the broiler chickens from excessive ingestion of the drinking water.

The second embodiment is different from the first embodiment in the breeding period of the broiler chickens and is substantially the same as the first embodiment in other breeding conditions. In each breeding experiment of the second embodiment, the result of body increase, the weight of internal organ, the concentration of internal organ fat and the property of blood were measured in the same manner as in the first embodiment. A result of the measurement is listed in the following tables 9-12.

TABLE 9
Result of body increase

Drinking water

| Item | TAP | BEW |
|---|---|---|
| Body weight at start (g) | 333.0 ± 8.0 | 333.4 ± 7.2 |
| Body weight at finish (g) | 910.5 ± 24.3 | 904.8 ± 25.3 |
| Ingestion amount of feed (g) | 1795 ± 47.8 | 1813 ± 47.3 |
| Efficiency of feed | 0.64 ± 0.02 | 0.63 ± 0.01 |

TABLE 10
Weight of internal organ (g)

Drinking water

| Item | TAP | BEW |
|---|---|---|
| Liver | 28.3 ± 1.0 | 30.5 ± 1.2 |
| Breast meat | 57.5 ± 2.2 | 53.9 ± 1.7 |
| Interperitoneal fat | 5.0 ± 0.8 | 6.8 ± 0.7 |

TABLE 11
Concentration of internal organ fat (%)

Drinking Water

| Item | TAP | BEW |
|---|---|---|
| Liver | 10.6 ± 0.41 | 11.5 ± 0.63 |
| Breast meat | 3.17 ± 0.31 | 3.17 ± 0.31 |

TABLE 12
Property of blood (mg/dL)

Drinking Water

| Item | TAP | TAP |
|---|---|---|
| TG | 32.3 ± 1.2 | 39.0 ± 1.6 |
| CHOL | 197.7 ± 6.1 | 1741 ± 6.3 |

The result of the second embodiment indicates that the electrolyzed mildly alkaline water is effective as the drinking water of the broiler chickens in breeding of them. As is listed in the table 10, it has been found that the water in the section (BEW) is effective in almost all the times except for the item of breast meat. When compared with the result of the embodiment 1, it has been confirmed that the result of the first embodiment is better than the result of the second embodiment. This was caused by the facts that the Nipple watering system was adapted to ingestion of the drinking water in a restricted amount and that the ingestion period of the drinking water (breeding period) was slightly shorter than that in the first embodiment.

1. A drinking water used with feed for breeding poultry, the drinking water being in the form of electrolyzed alkaline water produced by electrolysis of pure water in an electrolytic cell with an ion permeable membrane.

2. A drinking water as set forth in claim 1, wherein the electrolyzed alkaline water is mildly alkaline water of pH 8-11.

3. A breeding method of poultry with electrolyzed alkaline water produced by electrolysis of pure water in an electrolytic cell with an ion permeable membrane.

4. A breeding method of poultry as set forth in claim 3, wherein the electrolyzed alkaline water is mildly alkaline water of pH 8-11.
